(19) United States
(12) Patent Application Publication
(10) Pub. No.: US 2010/0003928 A1
(43) Pub. Date: Jan. 7, 2010

(54) METHOD AND APPARATUS FOR HEADER COMPRESSION FOR CDMA EVDO SYSTEMS

(75) Inventors: Dah-Lain Almon Tang, Naperville, IL (US); Hui Dai, Itasca, IL (US); Yingchun Xu, Vernon Hills, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/165,745

(22) Filed: Jul. 1, 2008

(51) Int. Cl. H04B 7/00

(52) U.S. Cl. 455/72

(57) ABSTRACT

A method and system for providing header compression guidance to mobile devices initiating certain applications and/or protocols. A selective header compression (SHC) utility utilizes a session initiation protocol (SIP) message to provide robust header compression (ROHC) guidance to a mobile device initiating a call involving selected (SIP related) applications, protocols and/or service options. In addition, ROHC guidance allows the mobile device to appropriately select the source and/or destination port (depending on packet origination) for data flows requiring ROHC. ROHC guidance may recommend that the mobile device request ROHC for VoIP flows, but not for video flows. Furthermore, the guidance may specify the range of real-time protocol (RTP) ports at which ROHC is applied. For example, within a specified range of RTP ports, ROHC may be applied to data transmissions via even port numbers but prevented for real-time transport control protocol (RTCP) flows via odd port numbers.

### BACKGROUND

1. Technical Field

The present invention generally relates to data processing systems and in particular to signaling in data processing systems.

2. Description of the Related Art

Robust Header Compression (ROHC) is a standardized method to compress the internet protocol (IP), user datagram protocol (UDP), real-time transport protocol (RTP), and transmission control protocol (TCP) headers of Internet packets. ROHC differs from other compression schemes such as Internet Engineering Task Force (IETF) Request for Comments (RFC) 1144 and RFC 2508 by the fact that ROHC performs well over links where the packet loss rate is high, such as wireless links. In streaming applications, the overhead of IP, UDP, and RTP is 40 bytes for IPv4, or 60 bytes for IPv6. For VoIP (Voice Over IP), the overhead corresponds to around 60% of the total amount of data sent. Such large overheads may be tolerable in wired links where capacity is often not an issue, but are excessive for wireless systems where bandwidth is scarce. ROHC compresses these 40 bytes or 60 bytes of overhead typically into only 1 or 3 bytes by placing a compressor before the link that has limited capacity, and a decompressor after that link. The compressor converts the large overhead to only a few bytes, while the decompressor executes the reverse conversion process.

IETF RFCs specify the details of ROHC compression algorithms and ROHC parameter negotiation during Point-to-Point Protocol (PPP) session setup. In general, ROHC may be performed with various other link layer protocols such as Ethernet (without using PPP). 3GPP2 (i.e., Third Generation Partnership Project 2) also specify the Enhanced Multi-flow Packet Applications (EMPA) and Traffic Flow Template (TFT) for mobile devices to indicate to the Packet Data Serving Node (PDSN) the specific set of flows to which ROHC is to be applied.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram representation of a data processing system that may be utilized as a server, according to one embodiment;

FIG. 2 illustrates a wireless network environment, in which a server provides robust header compression (ROHC) guidance to a mobile client running a particular set of applications, according to one embodiment;

FIG. 3 illustrates the ROHC guidance provided within a Session Initiation Protocol (SIP) registration reply message, according to one embodiment;

FIG. 4 illustrates a message flow diagram for providing ROHC guidance to a mobile client, according to one embodiment; and

FIG. 5 is a flow chart illustrating ROHC guidance to a mobile client, according to one embodiment.

### DETAILED DESCRIPTION OF AN ILLUSTRATIVE EMBODIMENT

The illustrative embodiments provide a method and system for providing header compression guidance to mobile devices initiating certain applications and/or protocols. A selective header compression (SHC) utility utilizes a session initiation protocol (SIP) message to provide robust header compression (ROHC) guidance to a mobile device initiating a call involving selected (SIP related) applications, protocols and/or service options. In addition, ROHC guidance allows the mobile device to appropriately select the source and/or destination port (depending on packet origination) for data flows that require ROHC. For example, ROHC guidance may recommend that the mobile device request ROHC for VoIP flows, but not for video flows. Furthermore, the guidance may specify the range of real-time protocol (RTP) ports at which ROHC is applied. For example, within a specified range of RTP ports, ROHC may be applied to data transmissions via even port numbers but prevented for real-time transport control protocol (RTCP) flows via odd port numbers.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

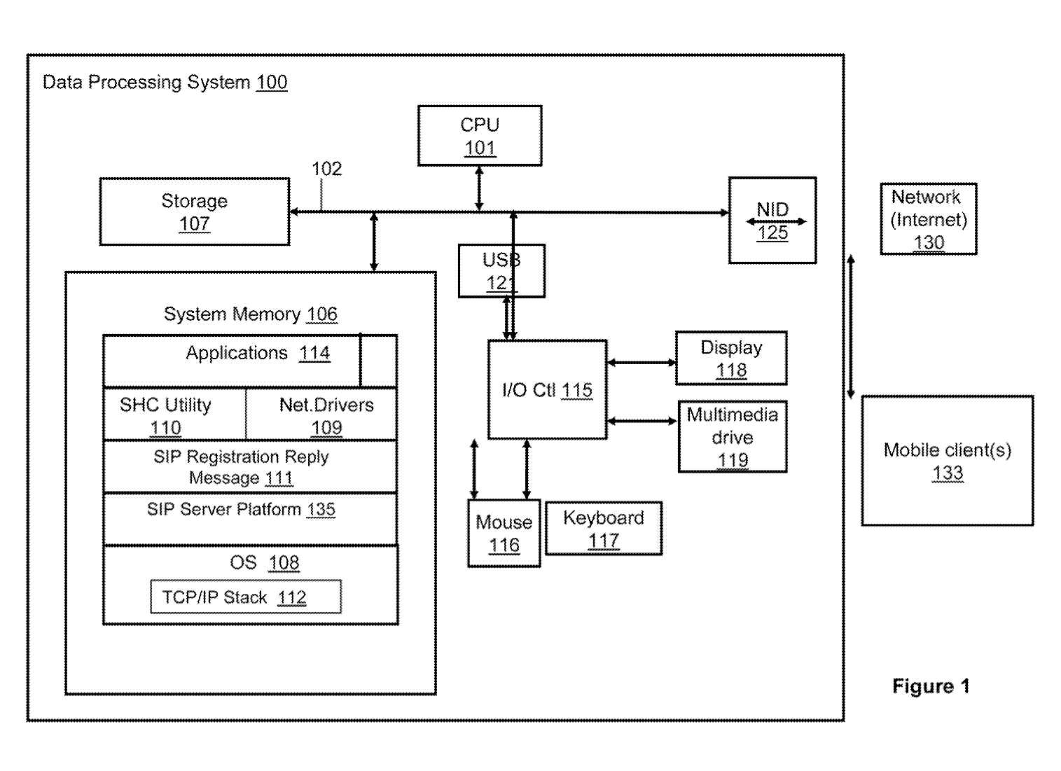

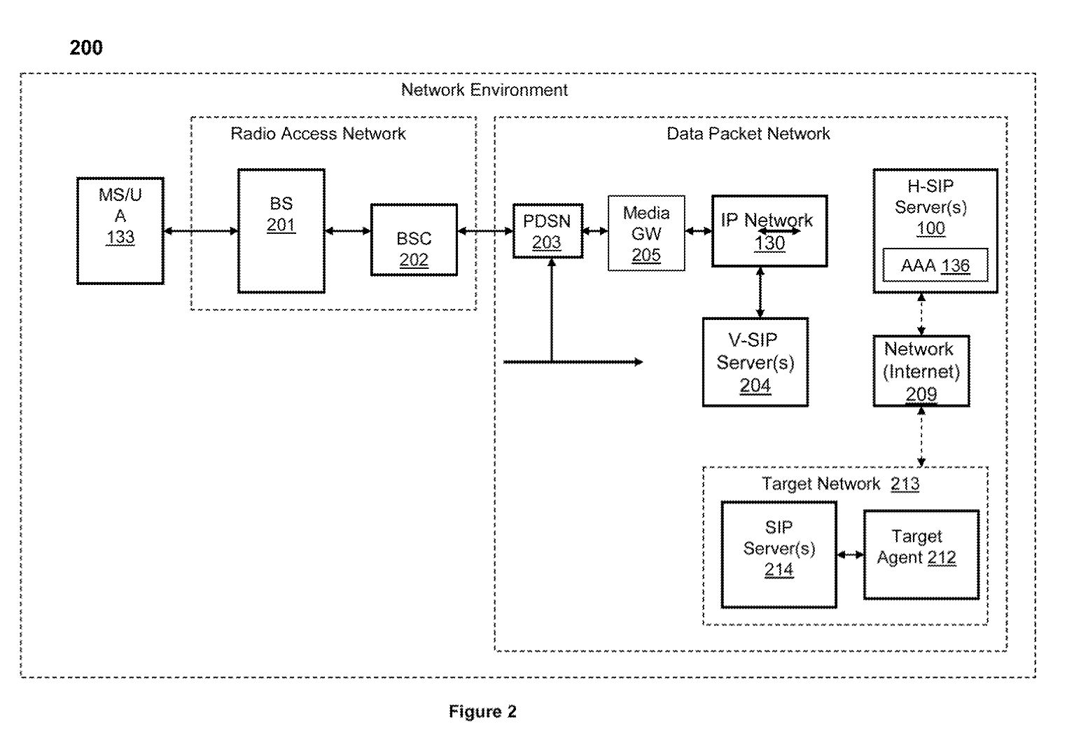

Within the descriptions of the figures, similar elements are provided similar names and reference numerals as those of the previous figure(s). Where a later figure utilizes the element in a different context or with different functionality, the element is provided a different leading numeral representative of the figure number (e.g, 1xx for FIGS. 1 and 2xx for FIG. 2). The specific numerals assigned to the elements are provided solely to aid in the description and not meant to imply any limitations (structural or functional) on the invention.

It is understood that the use of specific component, device and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that terms is utilized.

With reference now to FIG. 1, there is depicted a block diagram representation of a data processing system (DPS), which represents and is referred to hereinafter as a Session Initiation Protocol (SIP) Server, and in particular, Home SIP Server (H-SIP) 100. SIP Servers enable SIP endpoints to exchange messages, register user location, and seamlessly move between networks. H-SIP 100 comprises at least one processor or central processing unit (CPU) 101 connected to system memory 106 via system interconnect/bus 102. Also connected to system bus 102 is I/O controller 115, which provides connectivity and control for input devices, of which pointing device (or mouse) 116 and keyboard 117 are illustrated, and output devices, of which display 118 is illustrated. Additionally, a multimedia drive 119 (e.g., CDRW or DVD drive) and USB (universal serial bus) hub 121 are illustrated, coupled to I/O controller. Multimedia drive 119 and USB hub 121 may operate as both input and output (storage) mechanisms. H-SIP 100 also comprises storage 107, within which data/instructions/code may be stored.

In the described embodiments, network 130 is a worldwide collection of networks and gateways that utilize the Transmission Control Protocol/Internet Protocol (TCP/IP) suite of protocols to communicate with one another. Of course, network access may also be provided via a number of different types of networks, such as an intranet, a local area network (LAN), a virtual private network (VPN), or other wide area network (WAN) other than the Internet, for example.

Notably, in addition to the above described hardware components of H-SIP 100, various features of the invention are completed via software (or firmware) code or logic stored within memory 106 or other storage (e.g., storage 107) and executed by CPU 101. Thus, illustrated within memory 106 are a number of software/firmware components, including operating system (OS) 108, applications 114, SIP Server Platform 135, SIP Registration reply Message 111 and selective header compression (SHC) utility 110. Included within OS 108 is Transmission Control Protocol (TCP)/Internet Protocol (IP) stack illustrated as (TCP/IP) stack 112, which enables the transmission of data across a network. SIP Server Platform 135 provides the functionality of registrar, redirect and proxy servers. An SIP Registrar Server handles location registration messages. An SIP Redirect Server returns “contact this address” responses. An SIP Proxy Server forwards SIP requests and responses (e.g., SIP Registration reply Message 111). For simplicity, SHC utility 110 is illustrated and described as a stand alone or separate software/firmware component, which provides specific functions, as described below.

CPU 101 executes SHC utility 110 as well as OS 108, which supports the user interface features of SHC utility 110. Among the software code/instructions provided by SHC utility 110, and which are specific to the invention, are: (a) code for transmitting a signaling message to provide a set of transmission guidance information to the mobile client; (b) code for including the set of transmission guidance information within an SIP message; and (c) code for indicating (1) a group of applications and protocols for which header compression is preferred and (2) a set of source ports to be selected when compression is preferred. For simplicity of the description, the collective body of code that enables these various features is referred to herein as SHC utility 110. According to the illustrative embodiment, when CPU 101 executes SHC utility 110, H-SIP 100 initiates a series of functional processes that enable the above functional features as well as additional features/functionality, which are described below within the description of FIGS. 2-5.

Those of ordinary skill in the art will appreciate that the hardware and basic configuration depicted in FIG. 1 may vary. For example, other devices/components may be used in addition to or in place of the hardware depicted. The depicted example is not meant to imply architectural limitations with respect to the present invention.

With reference now to FIG. 2, a wireless (data transmission) network environment is illustrated, in which a network server provides robust header compression (ROHC) guidance to a mobile client running a particular set of applications, according to one embodiment of the invention. Network environment 200 comprises mobile station (MS) 133 which is wirelessly connected to base station (BS) 201. BS 201 is connected to packet data switching node (PDSN) 203 in the data packet network via base station controller (BSC) 202. BS 201 and base station controller (BSC) 202 collectively represent the Radio Access Network (RAN). In the data packet network, Visited SIP (V-SIP) server 204 is connected to PDSN 203. PDSN 203 is also connected to media gateway (GW) 205. In environment 200, Media GW 205 is connected to DPS 100/Home SIP (H-SIP) server 100 via Network 130.

At media gateway (205), data packets are converted to the data format required for transmission in IP network 130. A media gateway is any device, such as a circuit switch, IP gateway, or channel bank that converts data from the format required for one type of network to the format required for another. A media gateway may terminate channels from a circuit-switched network as well as streaming media from a packet-switched network such as RTP streams in an IP network. Additionally, Target Agent 212 and SIP Server 214 are illustrated within a target network (213).

Network environment 200 may, for example, represent a CDMA2000 EV-DO capable network environment. The acronym CDMA represents code division multiple access and EV-DO represents Evolution-Data Optimized.

EV-DO is a telecommunications standard for the wireless transmission of data through radio signals, typically for broadband Internet access. EV-DO uses multiplexing techniques including CDMA as well as time division multiple access (TDMA) to maximize both individual user's throughput and the overall system throughput. EV-DO is standardized by 3rd Generation Partnership Project 2 (3GPP2) as part of the CDMA2000 family of standards and has been adopted by many mobile phone service providers around the world, particularly providers previously employing CDMA networks. EV-DO was designed as an evolution of the CDMA2000 (IS-2000) standard to support high data rates and to be deployed alongside a wireless carrier's voice services. An EV-DO channel has a bandwidth of 1.25 MHz. Additionally, the back-end network is entirely packet-based, and thus is not constrained by the restrictions typically present on a circuit switched network. CDMA2000 is a hybrid 2.5G/3G technology of mobile telecommunications standards that use CDMA. CDMA2000 is considered a 3G technology in EV-DO. Furthermore, the illustrated embodiments described by network environment 200 may also be applied within a fourth/next generation (4G) Worldwide Interoperability for Microwave Access (WIMAX) Network.

In network environment 200, MS 133 may be represented by any mobile/wireless user equipment capable of obtaining IP (Internet Protocol) based packet data service within network environment 200. In particular, MS 133 may, for example, be represented by any personal computer (e.g., desktops, laptops, palmtops, or handheld computing devices) equipped with a suitable wireless modem (for example, an EV-DO modem), or a mobile communications device (e.g., cellular phones or data enabled handheld devices capable of receiving and sending messages, web browsing, etc), or any enhanced PDA device or integrated information appliance capable of email, video mail, Internet access, corporate data access, messaging, calendaring and scheduling, information management, etc.

BS 201 provides MS 133 with access to a circuit switched cellular telephony network. Furthermore, MS 133 connects to the data packet network segment of environment 200 via PDSN 203. In general, PDSN 203 is connected to media gateway 205. Media gateway 205 is further connected via IP network 130 to a number of Authentication, Authorization and Accounting (AAA) servers 136 (which may be integrated within H-SIP 100). The Authentication, Authorization and Accounting (AAA) servers 136 are utilized for managing packet data services on behalf of the mobile station 133, including providing access to external IP networks, such as Internet 209, for example. V-SIP server 204 may also be integrated with AAA server functionality and may operate as an access registrar (AR) when mobile station 133 is roaming.

When the user first makes a data call using the mobile station 133, a link layer protocol session (e.g., a Point-to-Point Protocol (PPP) session) is established with PDSN 203, which may authenticate mobile station 133 by communicating with an appropriate AAA server. For example, PDSN 203 may first communicate with V-SIP server 204 which in turn may communicate with AAA 136 within H-SIP server 100 (or vice versa). AAA 136/Home SIP server 100 verifies that mobile station 133 is a valid subscriber and determines what services are available for mobile station 133. After mobile station 133 is authenticated, mobile station 133 may use the IP Control Protocol (IPCP) to request an IP address for commencing a packet data session. In general operation, a packet data session describes an instance of continuous use of packet data service by the user of appropriate wireless IP equipment (e.g., mobile station 133). Typically, a packet data session begins when mobile station 133 invokes packet data service. The session ends when mobile station 133 or the network terminates the service.

In order for MS 133 to communicate with the wireless IP network, a PPP session is established between MS 133 and PDSN 203 of the wireless IP network. When the PPP session is established, an SIP registration request is sent to an SIP server. The request includes the address of the caller (in the From header field) and the address of the intended callee/target agent 212 (in the To header field).

SIP Servers enable SIP endpoints to exchange messages, register user location, and seamlessly move between networks. SIP Servers enable network operators to install routing and security policies, authenticate users and manage user locations. SIP Server applications may take many forms, but the SIP standard defines three general types of server functionality that apply to all SIP Servers, i.e., Proxy, Redirect, and Registrar servers. These standard functionalities may be used according to the needs of the specific implementation.

Based on a successful authentication of MS 133, an SIP reply message is initiated and enhanced with ROHC guidance at H-SIP Server (100). The enhanced message is then transferred to the mobile user. When initiating transmission of data from a particular application, the mobile user (133) inspects the ROHC guidance. Based on the guidance, the user (133) selects a port for transmission of the data. Application of ROHC begins when the user (e.g., MS 133) begins transmission of data (e.g., VOIP) for which ROHC is required, through the recommended port. The user begins transmission of data via Home Server 100 and ultimately to target user agent 212. Conversely, application of ROHC is turned off for another set of applications which, for example, may include Video data.

In addition, MS 133 may also exchange additional messages with an EVDO modem (which may be included within or connected to MS 133) to request ROHC and ROHC related information. MS 133 may also indicate to the EVDO modem that MS 133 may perform ROHC locally.

SHC utility 110 may occasionally initiate a process to update software pertaining to ROHC support at the server. Furthermore, when an update of ROHC support at the server takes place, SHC utility 110 may transmit a set of ROHC related data to reconfigure one or more of: (1) a number of network gateways; (2) one or more base-stations (201); (3) one or more base station controllers (202); (4) one or more PDSNs; and/or (5) one or more mobile stations.

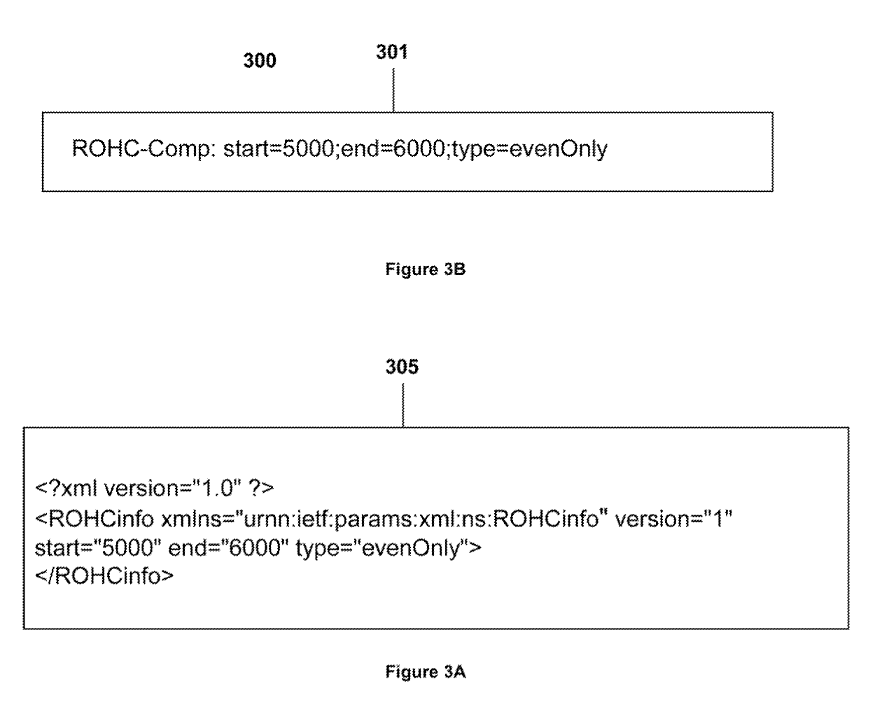

FIG. 3 illustrates the ROHC guidance provided within a Session Initiation Protocol (SIP) registration reply message, according to one embodiment of the invention. In particular, FIG. 3A illustrates a method by which ROHC guidance 301 is provided within the message header. Alternatively, FIG. 3B illustrates the ROHC guidance (ROHC guidance 305) within the message body. In both cases, the ROHC guidance indicates the source ports through which ROHC is applied to transmitted data. In these illustrative examples, ROHC guidance indicates that the source ports for the application of ROHC are all even numbered ports within the range of 5000 to 6000.

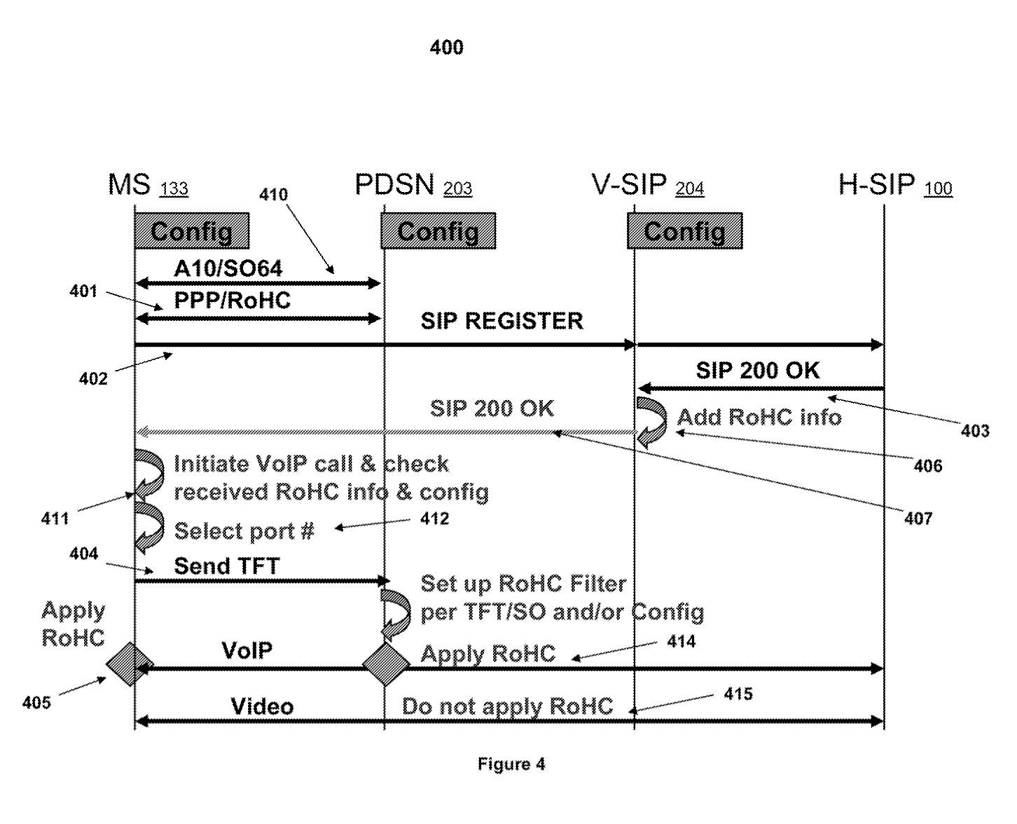

FIG. 4 illustrates a message flow diagram showing ROHC guidance transmission and ROHC application during a call initiated by a mobile client, according to one embodiment of the invention. In Message Flow 400, MS 133 utilizes a particular standard (e.g., A10, SO64) in order to initiate a data call (as illustrated by flow 410). In order for MS 133 to communicate with the wireless IP network, a PPP session is established (illustrated by flow 401) between MS 133 and PDSN 203 of the wireless IP network. In a CDMA2000 packet core network (PCN), PDSN 203 is responsible for supporting authentication mechanisms and a configuration option to allow MS 133 to receive IP services such as VoIP (Voice over IP). MS 133 and PDSN 203 are both ultimately connected to a Radio Access Network (RAN), which maintains a Point-to-Point Protocol (PPP) session between PDSN 203 and MS 133.

Once the PPP session is established (following flow 401), MS 133 sends a SIP REGISTER, which is a registration request, to H-SIP server 100, as illustrated by flow 402. The registration request includes the address of the caller (in the From header field) and the address of the intended target agent (in the To header field). H-SIP server 100 enables SIP endpoints to exchange messages, register user location, and seamlessly move between networks.

Since a SIP end user (for example, a user of MS 133) is able to move between end systems, the location of 133 may be dynamically registered with H-SIP server 100. Thus, the SIP request may first be received by a Visiting (V) SIP 204 and then forwarded to the Home (H) SIP 100. A SIP 200 OK message 403 is initiated by H-SIP Server 100 if the registration is successful, and the SIP 200 OK message 403 is enhanced with ROHC guidance 305 as illustrated by step 406 at V-SIP Server 204. The ROHC enhanced message is then transferred to the mobile user, MS 133, as flow 407 illustrates.

When initiating transmission of data from a particular application, MS 133 inspects the ROHC guidance, as shown by flow 411. The guidance provides an indication of the set of applications for which ROHC is provided, and the ports through which ROHC is applied. Based on a check of the guidance, MS 133 selects an appropriate port for the transmission of data (e.g., VOIP data), as illustrated by flow 412. MS 133 may use SIP to set up the VoIP call. In one embodiment, MS 133 sends SIP INVITE message to the correspondent node and receives SIP 200 OK as an indication that the invite is accepted. MS 133 then sends a traffic flow template (TFT) message (as illustrated by flow 404) to PDSN 203, which stores the TFT. Once stored in PDSN 203, the TFT enables packet classification and policing for downlink data transfer. The TFT may be used to block or allow packet data from reaching a location or to route packet data to locations other than a designated location.

In response to the TFT, an ROHC filter(s) is set up and application of ROHC begins (as illustrated by flow 405) when the user begins transmission of data (e.g., VOIP) for which ROHC is required, through the appropriate port. The transmission of data occurs via H-SIP Server 100 and is ultimately routed to a target user agent. ROHC application also takes place when (packet) data is being transmitted from PDSN 203, as indicated by flow 414. Conversely, application of ROHC to a communication between MS 133 and H-SIP 100 is turned off for another set of applications which, for example, may include communication of Video data, as indicated by flow 415.

In one embodiment, functionality of SHC utility 110 may be distributed on one or more of the base station, base station controller, the PDSN and/or the mobile communication device. Thus, SHC utility 110 may enable configuration(s) at both PDSN and mobile communication devices for RoHC to be performed only on flows for certain applications/protocols. The configuration may include port range and Service Options.

The PDSN may apply the configuration only when the RoHC indicator is not received but the RoHC has been negotiated with the mobile communication device. The mobile communication device may apply the configuration when the RoHC indicator can not be sent. The configuration may, for example, enable RoHC to be applied to VoIP RTP flows (as indicated by flow 414), but not video RTP flows (as indicated by flow 415). The configuration may further prevent RTCP or other UDP flows to be compressed.

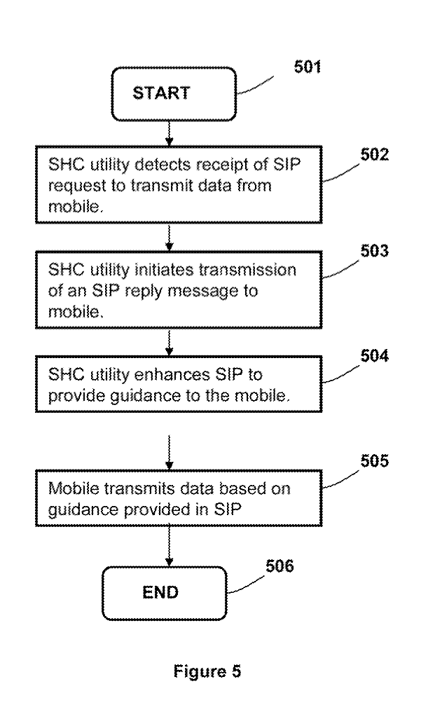

FIG. 5 is a flow chart illustrating a method by which the above processes of the illustrative embodiments are completed. Although the methods illustrated in FIG. 5 may be described with reference to components shown in FIGS. 1-4, it should be understood that this is merely for convenience and alternative components and/or configurations thereof can be employed when implementing the various methods. Key portions of the methods may be completed by SHC utility 110 executing within DPS 100 (FIG. 1) and controlling specific operations of/on DPS 100, and the methods are thus described from the perspective of either/both SHC utility 110 and DPS 100.

The process of FIG. 5 begins at initiator block 501 and proceeds to block 502, at which SHC utility 110 detects receipt of a SIP registration request from a mobile user. At block 503, SHC utility 110 then initiates transmission of an SIP Reply message to the mobile user. SHC utility 110 enhances the SIP reply message to provide ROHC guidance to the mobile, as shown at block 504. The mobile user then transmits data based on the ROHC guidance provided in the SIP reply message, as shown at block 505. The process ends at block 506.

In the flow charts above, one or more of the methods are embodied as a computer program product in a computer readable medium or containing computer readable code such that a series of steps are performed when the computer readable code is executed on a computing device. In some implementations, certain steps of the methods are combined, performed simultaneously or in a different order, or perhaps omitted, without deviating from the spirit and scope of the invention. Thus, while the method steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

Generally, the above illustrated and described embodiments implemented within a data network provide a communication device and a method for: (1) receiving a registration request to initiate transmission of data from a mobile client; (2) transmitting a reply message with a set of transmission guidance information to the mobile client, which transmission guidance information indicates port and compression information to be utilized by the mobile client for transmission of the data; and (3) subsequently receiving data from the mobile client based on the port and compression information within the transmission guidance information. The data is transmitted according to the set of transmission guidance.

The illustrated and described embodiments also provide a method for providing the set of transmission guidance information within a header of an SIP and/or a message body of the SIP. Furthermore, the transmission guidance information indicates (1) a group of applications and a group of protocols for which header compression is preferred and/or a set of source ports to be selected when header compression is preferred.

One embodiment further provides a communication device having a processing component and a transceiver for receiving and sending data communication to and from the device. The communication device also has a memory on which is stored a utility which executes on the processing component to enable the communication device to perform the functions of: (1) activating a set of transmission guidance information, which transmission guidance information indicates port and compression information to be utilized by the communication device for transmission of data; and (2) subsequently transmitting the data based on the port and compression information within the transmission guidance information, wherein the data is transmitted according to the set of transmission guidance. The communication device may be one of a mobile station, a base-station, a base station controller, or a packet data switching node (PDSN), and may or may not require a SIP message from the operator/application server to perform the ROHC processing of data.

As will be further appreciated, the processes in embodiments of the present invention may be implemented using any combination of software, firmware or hardware. As a preparatory step to practicing the invention in software, the programming code (whether software or firmware) will typically be stored in one or more machine readable storage mediums such as fixed (hard) drives, diskettes, optical disks, magnetic tape, semiconductor memories such as ROMs, PROMs, etc., thereby making an article of manufacture (or computer program product) in accordance with the invention. The article of manufacture containing the programming code is used by either executing the code directly from the storage device, by copying the code from the storage device into another storage device such as a hard disk, RAM, etc., or by transmitting the code for remote execution using transmission type media such as digital and analog communication links. The methods of the invention may be practiced by combining one or more machine-readable storage devices containing the code according to the present invention with appropriate processing hardware to execute the code contained therein. An apparatus for practicing the invention could be one or more processing devices and storage systems containing or having network access to program(s) coded in accordance with the invention.

Thus, it is important that while an illustrative embodiment of the present invention is described in the context of a fully functional computer (server) system with installed (or executed) software, those skilled in the art will appreciate that the software aspects of an illustrative embodiment of the present invention are capable of being distributed as a computer program product in a variety of forms, and that an illustrative embodiment of the present invention applies equally regardless of the particular type of media used to actually carry out the distribution. By way of example, a non exclusive list of types of media, includes recordable type (tangible) media such as floppy disks, thumb drives, hard disk drives, CD ROMs, DVDs, and transmission type media such as digital and analogue communication links.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. In a data network comprising an application server and one or more mobile clients, a method comprising:
receiving a registration request to initiate transmission of data from a mobile client;
transmitting a reply message with a set of transmission guidance information to the mobile client, which transmission guidance information indicates port and compression information to be utilized by the mobile client for transmission of the data; and
subsequently receiving data from the mobile client based on the port and compression information within the transmission guidance information, wherein the data is transmitted according to the set of transmission guidance.

2. The method of claim 1, wherein said transmitting further comprises:
providing the set of transmission guidance information within one or both of a header of a session initiation protocol (SIP) message and a message body of the SIP message;
wherein said set of transmission guidance information indicates one or more of (a) a group of applications and a group of protocols for which header compression is preferred and (b) a set of source ports to be selected when header compression is preferred.

3. The method of claim 1, wherein:
the transmission guidance information is robust header compression (ROHC) guidance; and
the ROHC guidance enables appropriate selection of one or more of the source port and destination port, based on respective packet origination, for data flows that require ROHC.

4. The method of claim 3, further comprising:
when the ROHC support at the application server is updated, transmitting a set of ROHC related data to reconfigure at least one of: one or more network gateways; one or more base-stations; one or more base station controllers; one or more packet data switching nodes (PDSNs); and one or more mobile stations.

5. The method of claim 4, further comprising:
providing a first configuration to the PDSN and a second configuration to the mobile device, wherein at least one of said first configuration and said second configuration enables an application of RoHC to be performed on flows for pre-identified applications and protocols and prevents the application of RoHC on flows of other pre-identified applications, wherein said first and second configurations include port range and Service Options;
wherein the first configuration enables said PDSN to apply said first configuration when an RoHC indicator is not received at the PDSN and the RoHC is previously negotiated with the mobile client; and
wherein the second configuration enables said mobile device to apply said second configuration when the RoHC indicator is not transferable.

6. The method of claim 1, wherein the data is data transmitted by the mobile device initiating a call involving one or more of selected applications, protocols and service options.

7. The method of claim 1, further comprising:
detecting a receipt of a message from the mobile client, wherein said message indicates an initiation of a header compression process at the mobile client and wherein said message provides an additional set of header compression related information; and
in response to the receipt of the message, identifying an appropriate set of ports at which to receive the data from the mobile client, based on the header compression process and related information; and
receiving the data at the identified appropriate set of ports.

8. A communication device comprising:
a processor;
a memory system which stores a session initiation protocol (SIP) server platform;
a selective header compression (SHC) utility, which when executed on the processor provides the functionality of:
receiving a registration request to initiate transmission of data from a mobile client;
transmitting a reply message with a set of transmission guidance information to the mobile client, which transmission guidance information indicates port and compression information to be utilized by the mobile client for transmission of the data; and
subsequently receiving data from the mobile client based on the port and compression information within the transmission guidance information, wherein the data is transmitted according to the set of transmission guidance.

9. The communication device of claim 8, wherein the transmitting function further provides the function of:
providing the set of transmission guidance information within one or both of a header of a session initiation protocol (SIP) message and a message body of the SIP message;
wherein said set of transmission guidance information indicates one or more of (a) a group of applications and a group of protocols for which header compression is preferred and (b) a set of source ports to be selected when header compression is preferred.

10. The communication device, wherein
the transmission guidance information is robust header compression (ROHC) guidance; and
the ROHC guidance enables appropriate selection of one or more of the source port and destination port, based on respective packet origination, for data flows that require ROHC.

11. The communication device of claim 10, wherein said SHC utility further executes to provide the functionality of:
when the ROHC support at the application server is updated, transmitting a set of ROHC related data to reconfigure at least one of: one or more network gateways; one or more base-stations; one or more base station controllers; one or more packet data switching nodes (PDSNs); and one or more mobile stations.

12. The communication device of claim 11, wherein said SHC utility further executes to provide the functionality of:
providing a first configuration to the PDSN and a second configuration to the mobile device, wherein at least one of said first configuration and said second configuration enables an application of RoHC to be performed on flows for pre-identified applications and protocols and prevents the application of RoHC on flows of other pre-identified applications, wherein said first and second configurations include port range and Service Options;
wherein the first configuration enables said PDSN to apply said first configuration when an RoHC indicator is not received at the PDSN and the RoHC is previously negotiated with the mobile client; and
wherein the second configuration enables said mobile device to apply said second configuration when the RoHC indicator is not transferable.

13. The communication device of claim 8, wherein the data is data transmitted by the mobile device initiating a call involving one or more of selected applications, protocols and service options.

14. The communication device of claim 8, wherein said SHC utility further executes to support the functionality of:
detecting a receipt of a message from the mobile client, wherein said message indicates an initiation of a header compression process at the mobile client and wherein said message provides an additional set of header compression related information; and
in response to the receipt of the message, identifying an appropriate set of ports at which to receive the data from the mobile client, based on the header compression process and related information; and
receiving the data at the identified appropriate set of ports.

15. A communication device comprising:
a processing component;
a transceiver for receiving and sending data communication to and from the device;
a memory having stored thereon a utility which executes on the processing component to enable the communication device to perform the functions of:
activating a set of transmission guidance information, which transmission guidance information indicates port and compression information to be utilized by the communication device for transmission of data; and
subsequently transmitting the data based on the port and compression information within the transmission guidance information, wherein the data is transmitted according to the set of transmission guidance.

16. The communication device of claim 15, wherein said utility further executes to provide to enable the functions of:
receiving the set of transmission guidance information within one or both of a header of a session initiation protocol (SIP) message and a message body of the SIP message;
wherein said set of transmission guidance information indicates one or more of (a) a group of applications and a group of protocols for which header compression is preferred and (b) a set of source ports to be selected when header compression is preferred.

17. The communication device of claim 16, wherein
the transmission guidance information is robust header compression (ROHC) guidance; and
the ROHC guidance enables appropriate selection of one or more of the source port and destination port, based on respective packet origination, for data flows that require ROHC.

18. The communication device of claim 16, wherein the utility further supports the functions of:
receiving an ROHC guidance from a remote operator/application server, which provides updates required for the data transmission protocol.
receiving a set of ROHC related data to reconfigure the communication device when the ROHC support at the operator/application server is updated.

19. The communication device of claim 15, wherein said utility further executes to enable the functions of:
transmitting a message to an application server, wherein said message indicates an initiation of a header compression process at the mobile client and wherein said message provides an additional set of header compression related information; and
wherein, in response to the receipt of the message, the application server identifies an appropriate set of ports at which to receive the data from the communication device, based on the header compression process and related information; and
transmitting the data directed to the identified appropriate set of ports with the indicated header compression.

20. The communication device of claim 15, wherein the device is one of a mobile station, a base station, a base station controller, or a packet data switching node.
